(19) United States
(12) Patent Application Publication
(10) Pub. No.: US 2011/0255166 A1
(43) Pub. Date: Oct. 20, 2011

(54) OPTICAL FILTER DEVICE, OPTICAL FILTER MODULE AND ANALYSIS APPARATUS

(75) Inventors: Susumu SHINTO, Suwa (JP); Akira SANO, Shiojiri (JP)

(73) Assignee: SEIKO EPSON CORPORATION, Tokyo (JP)

(21) Appl. No.: 13/085,004

(22) Filed: Apr. 12, 2011

(30) Foreign Application Priority Data
Apr. 19, 2010 (JP) 2010-095711

(51) Int. Cl. G02B 27/00

(52) U.S. Cl. 359/577

(57) ABSTRACT

An optical filter device includes a first electrode that is provided on a first substrate, a second electrode that is provided on a second substrate to face the first electrode, a pair of first lead-out electrodes that connects to the first electrode, and a pair of second lead-out electrodes that is provided on the second substrate to connect to the second electrode.

### BACKGROUND

1. Technical Field

The present invention relates to an optical filter device that extracts a specific wavelength of light, an optical filter module and an analysis apparatus.

2. Related Art

In the related art, a wavelength-variable interference filter (optical filter device), which extracts a specific wavelength of light from a plurality of wavelengths of light, is known (see JP-A-2008-116669).

The wavelength-variable interference filter disclosed in JP-A-2008-116669 includes a first structure and a second structure that faces the first structure. The second structure is formed to a plate shape and has a movable portion capable of being displaced in a thickness direction thereof. The first structure includes a first reflection film and a first driving electrode formed at a periphery side of the first reflection film, at a region facing the movable portion. The second structure includes a second reflection film facing the first reflection film and a second driving electrode facing the first driving electrode, at the movable portion. In addition, the first structure has a lead-out electrode formed to extend from an outer circumferential edge of the first driving electrode toward the outside, and the second structure has a lead-out electrode formed to extend from an outer circumferential edge of the second driving electrode toward the outside.

In such a wavelength-variable interference filter, when a voltage is applied to each of the lead-out electrodes, which is connected to the first or the second driving electrode, the movable portion is displaced by an electrostatic attractive force toward the first structure, and thereby the size of a gap between the first and second reflection films is varied. Therefore, in the light incident to the wavelength-variable interference filter, light of a wavelength corresponding to the size of the gap is extracted.

However, in the wavelength-variable interference filter disclosed in JP-A-2008-116669, the lead-out electrode for applying the driving voltage to the first driving electrode and the lead-out electrode for applying the driving voltage to the second driving electrode are each provided one by one.

Here, in the wavelength-variable interference filter, the size of the gap between the first and second reflection films is extremely small, and, for example, is formed so that the displacement is possible within a range of 200 to 500 nm. As described above, when the driving electrode is formed in a narrow region, the thickness dimension of the driving electrode needs to be made thin. In this case, when the lead-out electrode is formed to have the same thickness dimension as that of the driving electrode, the resistance of the lead-out electrode increases. This may cause a problem in terms of interconnection reliability as an increase in power consumption, disconnections and the like occur.

### SUMMARY

An advantage of some aspects of the invention is to provide an optical filter device, an optical filter module, and analysis apparatus, in which power-saving is achieved and interconnection reliability is increased.

According to an aspect of the invention, there is provided an optical filter device including a first substrate; a second substrate that faces the first substrate; a first reflection film that is provided on the first substrate; a second reflection film that is provided on the second substrate to face the first reflection film; a first electrode that is provided on the first substrate; a second electrode that is provided on the second substrate to face the first electrode; a pair of first lead-out electrodes that is provided on the first substrate to connect to the first electrode; and a pair of second lead-out electrodes that is provided on the second substrate to connect to the second electrode.

In this aspect, a pair of first lead-out electrodes connects to the first electrode of the optical filter device, and a pair of second lead-out electrodes connects to the second electrode. Therefore, the driving voltage may be applied by the pair of first lead-out electrodes to the first electrode and may be applied by the pair of second lead-out electrodes to the second electrode. The electric resistance may be decreased as a whole, compared to a case where a single lead-out electrode connects to the first electrode or the second electrode. Therefore, when an electrostatic attractive force is made to act between the first and second electrode to change the size of the gap, the size of the gap between the first and second reflection films may be changed by a relatively low driving voltage and thereby power-saving may be achieved.

In addition, even when either one of the pair of first lead-out electrodes is disconnected or either one of the pair of second lead-out electrodes is disconnected, if the other first lead-out electrode or the other second lead-out electrode is not disconnected, the voltage may be applied to the first electrode or the second electrode, and thereby the interconnection reliability may be improved.

In the optical filter device of this aspect, it is preferable that, in a plan view of the first and second substrates seen in a thickness direction, the first lead-out electrodes and the second lead-out electrodes are disposed at positions not overlapping each other.

In this aspect, the first and second lead-out electrodes are provided at positions not overlapping each other. Specifically, in a case where in a plan view, the first and second lead-out electrodes are provided at positions overlapping each other, there is a concern that the electrostatic attractive force acts between the first and second lead-out electrodes, such that the size of the gap between the first and second reflection films may not be constant and thereby the first and second reflection films may not be maintained to be parallel. In addition, there is a concern that a leakage current caused by dielectric breakdown may occur between the substrates, it may become impossible to adjust the size of the gap between the first and second reflection films, and the time necessary for adjusting the gap may become longer. Contrary to this, in the above-described aspect, the first and second lead-out electrodes are provided at positions not overlapping each other, in a plan view. By so doing, it is possible to stably drive the optical filter device without the generation of the leakage current or the electrostatic attractive force between the first and second lead-out electrodes.

Here, in the optical filter device of this aspect, it is preferable that the first and second substrates are formed in a rectangular shape, the pair of first lead-out electrodes is disposed at positions that are in point symmetry with respect to a substrate center on a diagonal line of the first substrate, and the pair of second lead-out electrodes is disposed at positions that are in point symmetry with respect to a substrate center on a diagonal line of the second substrate.

In this aspect, each of the pair of first lead-out electrodes is disposed at positions that are in point symmetry with respect to a substrate center along a diagonal line of the rectangular-shaped first substrate. Likewise, each of the pair of second lead-out electrodes is disposed at positions that are in point symmetry with respect to a substrate center along a diagonal line of the rectangular-shaped second substrate. Therefore, the first and second lead-out electrodes do not face each other, such that it is possible to prevent the generation of the leakage current and the electrostatic attractive force between the lead-out electrodes and to stably drive the optical filter device.

In addition, when the electrostatic attractive force acts between the first and second electrodes, either the first substrate or the second substrate is bent toward the other substrate, and thereby the size of the gap between the first and second reflection film is adjusted. At this time, the first lead-out electrodes are disposed to be in point symmetry with respect to a substrate center, such that when the first substrate is bent toward the second substrate, it is possible to allow the stress balance of the bending to be equal. Also, when the second substrate is bent toward the first substrate, it is possible to allow the stress balance of the bending to be equal. Therefore, it is possible to allow the bending balance of each of the substrates to be equal, to maintain the parallel state of the first and second reflection films in a good state, and to more stably drive the optical filter device.

In the optical filter device of this aspect, it is preferable that at least one of the first and second substrates has concave grooves corresponding to positions where the pair of first lead-out electrodes and the pair of second lead-out electrodes are disposed, in a plan view of the first and second substrates seen in a thickness direction.

In this aspect, concave grooves corresponding to the first lead-out electrode and the second lead-out electrodes are formed in the first substrate and the second substrates, and the first lead-out electrode or the second lead-out electrode are disposed in the concave grooves. Therefore, when the first and second substrate are bonded, the first lead-out electrode or the second lead-out electrode is not interposed at a bonding portion of the first and second substrates.

Here, at the time of bonding the first and second substrates, the first lead-out electrode or the second lead-out electrode is interposed at the bonding portion, the first and second substrates are distorted by the thickness dimension of these electrodes, and thereby there is a problem in that it is difficult to maintain the first and second reflection films in a parallel state. In regard to this, in this aspect of the invention, the first lead-out electrode or the second lead-out electrode is not interposed at the bonding portion of the first and second substrates, and thereby the electrodes do not become a cause of the distortion at the time of bonding the first and second substrates. Therefore, it is possible to maintain the first and second reflection films in a parallel state and thereby it is possible to stably operate the optical filter device.

According to another aspect of the invention, there is provided an optical filter module including the above-described optical filter device.

Here, as the optical filter module, for example, an optical filter module that receives light extracted by the optical filter device and outputs a light-receiving amount as an electric signal may be exemplified.

As described above, in the optical filter device, a pair of first lead-out electrodes connects to the first electrode and a pair of second lead-out electrodes connects to the second electrode, whereby, by decreasing the electric resistance at the lead-out electrodes, it is possible to decrease the power consumption. Therefore, in the optical filter module including the optical filter device, it is also possible to decrease the power consumption.

In addition, it is possible to improve the interconnection reliability of the optical filter device, and thereby it is also possible to improve the reliability of the optical filter module.

According to still another aspect of the invention, there is provided an analysis apparatus including the-above described optical filter module.

Here, as the analysis apparatus, a light measurement device that analyses chromaticity or brightness of the light incident to the optical filter module based on an electric signal output from the above-described optical filter module, a gas detection device that detects an absorption wavelength of gas to examine the sort of gas, an optical communication device that obtains data contained in a wavelength of light from received light, or the like can be exemplified.

In this aspect of the invention, as described above, it is possible to achieve the decrease in power consumption and improvement in reliability, and thereby in the measuring device including the optical filter module, it is also possible to achieve the decrease in power consumption and improvement in reliability.

### BRIEF DESCRIPTION OF THE DRAWINGS

The invention will be described with reference to the accompanying drawings, wherein like numbers reference like elements.

FIG. 1 is a view illustrating a schematic configuration of a color measuring device according to an embodiment of the invention;

FIG. 2 is a plan view illustrating a schematic configuration of an etalon that is an optical filter device of the embodiment;

FIG. 3 is a cross sectional view of the etalon seen from a line III-III of FIG. 2; and

FIG. 4 is an exploded perspective view of the etalon.

### DESCRIPTION OF EXEMPLARY EMBODIMENTS

Hereinafter, description will be given to a coloring measuring device that is an analysis apparatus according to an embodiment of the invention with reference to accompanying drawings.

### 1. Entire Configuration of Color Measuring Device

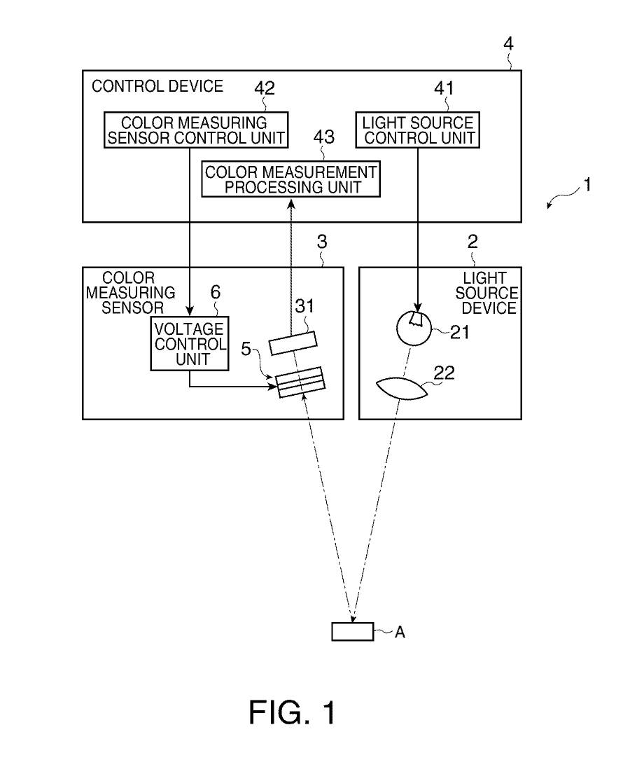

FIG. 1 shows a view illustrating a schematic configuration of a color measuring device according to a first embodiment of the invention.

As shown in FIG. 1, the color measuring device 1 includes a light source device 2 that emits light to an object A to be inspected, a color measuring sensor 3 that makes up an optical filter module of the embodiment of the invention, and a control device 4 that controls the entire operation of the color measuring device 1. The color measuring device 1 reflects the light emitted from the light source 2 onto the object A to be inspected, receives the reflected light to be inspected by the color measuring sensor 3, and analyzes chromaticity of the light to be inspected, on the basis of a detected signal output from the color measuring sensor 3. That is, the color measuring device 1 is a device that analyzes and measures a color of the object A to be inspected.

### 2. Configuration of Light Source

The light source device 2 includes a light source 21 and a plurality of lenses 22 (one lens is shown in FIG. 1), and emits white light to the object A to be inspected. In addition, a collimator lens is included in the plurality of lenses 22. The light source device 2 makes the white light emitted from the light source 21 be parallel light by using the collimator lens and emits the parallel light to the object A to be inspected from a projection lens (not shown).

### 3. Configuration of Light Measuring Sensor

The color measuring sensor 3 makes up the optical filter module of the embodiment of the invention. As shown in FIG. 1, the color measuring sensor 3 includes an etalon 5 making up the optical filter device of the embodiment of the invention, a light receiving element 31 as a light receiving means receiving light transmitting through the etalon 5, and a voltage control unit 6 that varies the wavelength of the light transmitted through the etalon 5. In addition, the color measuring sensor 3 includes, at a position facing the etalon 5, an incident optical lens (not shown) that guides the light (light to be inspected) that is reflected on the object A to be inspected, to the inside. Using the etalon 5, the color measuring sensor 3 disperses only a predetermined wavelength of light from within the light to be inspected, which is incident from the incident optical lens, and the dispersed light is received by the light receiving element 31.

The light receiving element 31 is constituted by a plurality of photoelectric conversion elements and generates an electric signal corresponding to a light-receiving amount. The light receiving element 31 connects to the control device 4 and outputs a generated electric signal to the control device 4 as a light-receiving signal.

### 3-1. Configuration of Etalon

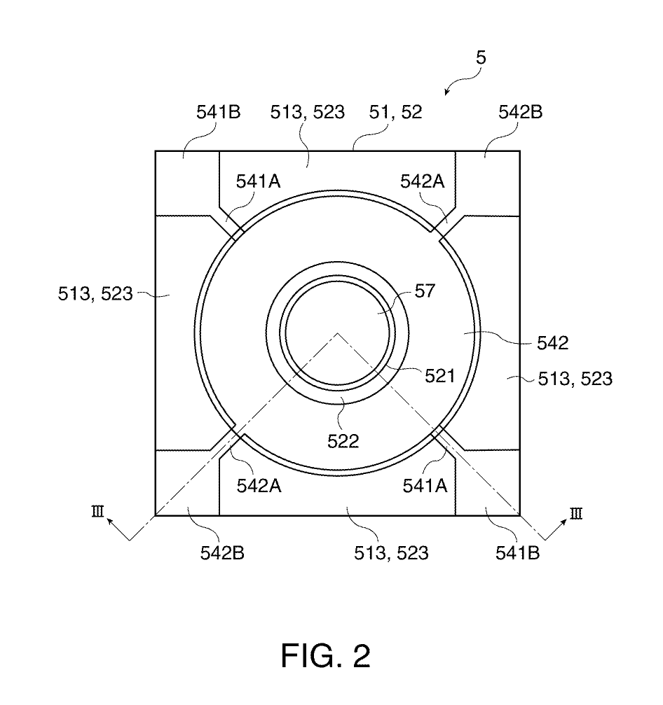

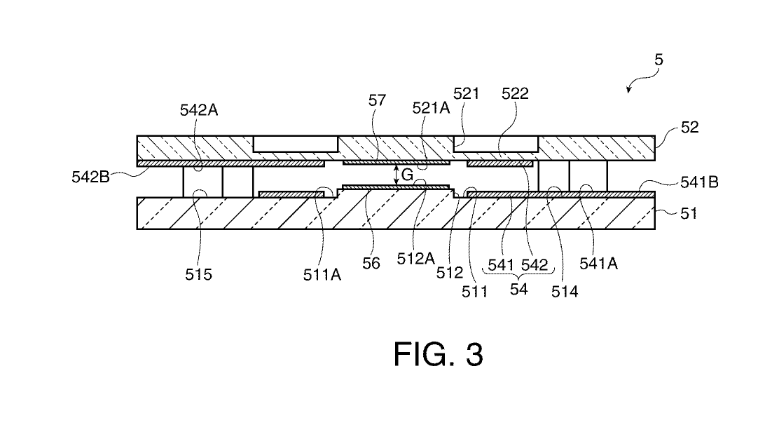

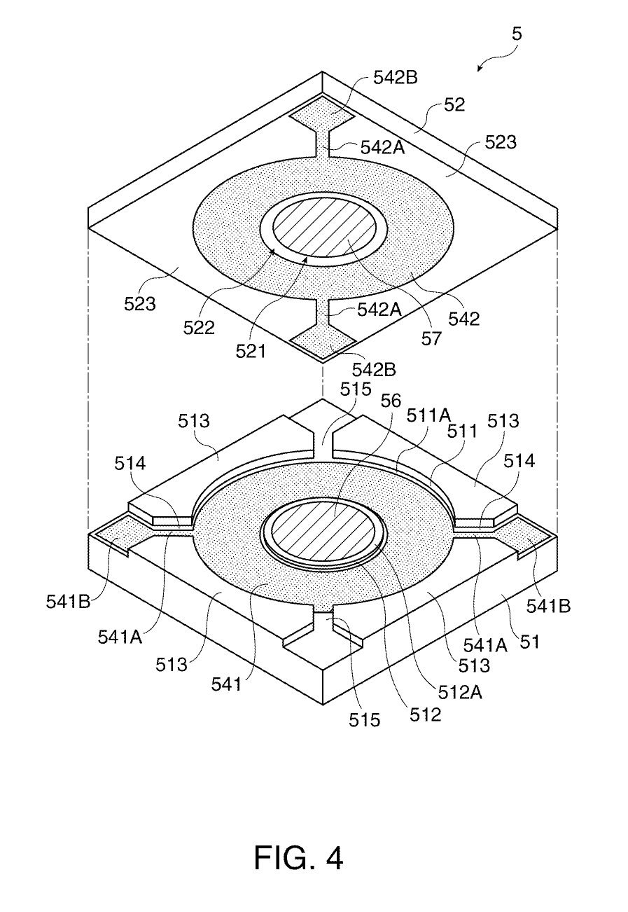

FIG. 2 shows a plan view showing a schematic configuration of the etalon 5 making up a wavelength-variable interference filter of the embodiment of the invention, and FIG. 3 shows a cross sectional view illustrating a schematic configuration of the etalon 5. FIG. 4 shows an exploded perspective view of the etalon 5 in which a first substrate 51 and a second substrate 52 are separated. In addition, in FIG. 1, the light to be inspected is incident to the etalon 5 from a lower side of FIG. 1, but in FIG. 3, the light to be inspected is incident from an upper side of FIG. 3.

As shown in FIG. 2, the etalon 5 is a square plate-shaped optical member and one side thereof has, for example, a length of 10 mm. As shown in FIG. 3, the etalon 5 includes first and second substrates 51 and 52. The two sheets of substrates 51 and 52 are formed from various glass such as a soda glass, a crystalline glass, a quartz glass, a lead glass, a potassium glass, a borosilicate glass and an alkali-free glass or a crystal. Among them, as a constitutional material of each of the substrates 51 and 52, for example, a glass containing an alkali metal such as sodium (Na) and potassium (K) is preferable. Each of the substrates 51 and 52 is formed from the glass described above, such that the adhesiveness of reflection films 56 and 57 and each electrode described below, and the bonding strength between substrates are improved. The substrates 51 and 52 are integrally formed through a pressure-bonding such as a normal temperature activation bonding at bonding surfaces 513 and 523 formed around the periphery thereof.

In addition, first and second reflection films 56 and 57 making up a pair of reflection films of the embodiment of the invention are provided between the first and second substrates 51 and 52. Here, the first reflection film 56 is fixed at a surface of the first substrate 51, which faces the second substrate 52, and the second reflection film 57 is fixed at a surface of the second substrate 52, which faces the first substrate 51. In addition, the first and second reflection films 56 and 57 are disposed to face each other via a gap G.

In addition, an electrostatic actuator 54 that adjusts the gap G between the first and second reflection films 56 and 57 is provided between the first and second substrates 51 and 52.

### 3-1-1. Configuration of First Substrate

The first substrate 51 is formed by etching, for example, a glass base material having a thickness of 500 μm. Specifically, as shown in FIGS. 3 and 4, the first substrate 51 has an electrode forming groove 511 and a reflection film fixing portion 512 that are formed through the etching.

The electrode forming groove 511 is formed to have a circle shape with a plane center point made as the center in a plan view (hereinafter, referred to as “etalon plan view”) seen in a thickness direction of the etalon 5 as shown in FIG. 2. The reflection film fixing portion 512 is formed to protrude, in the plan view, from a center portion of the electrode forming groove 511 to the second substrate 52 side.

The electrode forming groove 511 has an electrode fixing surface 511A formed in a ring shape between an outer circumferential edge of the reflection film fixing portion 512 and an inner circumferential wall surface of the electrode forming groove 511. On the electrode fixing surface 511A, a ring-shaped first electrode 541 is formed.

In addition, the first substrate 51 has first and second concave grooves 514 and 515 of the embodiment of the invention, which are formed from the electrode forming groove 511 toward an apical direction of the first substrate 51.

Specifically, the first concave grooves 514 are diagonally formed in the first substrate 51 from the electrode forming groove 511 toward a left-upper apex and a right-lower apex of the first substrate 51. The second concave grooves 515 are diagonally formed in the first substrate 51 from the electrode forming groove 511 toward a left-lower apex and a right-upper apex of the first substrate 51. The first and second concave grooves 514 and 515 have the same width dimension to each other and have the same depth dimension as that of the electrode forming groove 511, respectively.

As shown in FIG. 2, the first lead-out electrodes 541A are formed in the first concave grooves 514 to extend from a part of outer circumferential edge of the first electrode 541 toward a right-lower direction and a left-upper direction of the etalon 5 in the etalon plan view. At a distal end of each of the first lead-out electrodes 541A, a first electrode pad 541B is formed. The first electrode pads 541B connect to the voltage control unit 6.

Here, when the electrostatic actuator 54 is operated, a voltage is applied to the pair of first electrode pads 541B by the voltage control unit 6, respectively. In such a configuration, even when either one of the pair of first lead-out electrodes 541A is disconnected, the voltage may be applied to the first electrode 541 from the other first lead-out electrode 541A.

In addition, in a configuration where the first electrode 541 is connected to the voltage control unit 6 by the pair of first lead-out electrodes 541A, the electric resistance may be decreased compared to a configuration where a single first lead-out electrode 541A is provided and thereby energy loss caused by the increase of the electric resistance may be decreased. Therefore, a driving voltage necessary for applying a predetermined charge to the first electrode 541 may be decreased and thereby power-saving may be achieved.

In addition, one of the first lead-out electrodes 541A is extracted from the left-upper end edge of the ring-shaped first electrode 541 and the other is extracted from the right-lower end edge of the first electrode 541. Therefore, in the first electrode 541, a parallel circuit is formed between the first lead-out electrode 541A extracted toward the left-upper direction and the first lead-out electrode 541A extracted toward the right-lower direction, and thereby the electric resistance in the first electrode 541 may be decreased.

As described above, the reflection film fixing portion 512 is formed coaxially with the electrode forming groove 511, on a circumference having a diameter smaller than that of the electrode forming groove 511.

As shown in FIG. 3, there is disclosed an example where a reflection film fixing surface 512A of the reflection film fixing portion 512, which faces the second substrate 52, is formed close to the second substrate 52, compared to the electrode fixing surface 511A, but the invention is not limited thereto. The height position of each of the electrode fixing surface 511A and the reflection film fixing surface 512A is appropriately set depending on a dimension of the gap G between the first reflection film 56 fixed on the reflection film fixing surface 512A and the second reflection film 57 formed on the second substrate 52, a dimension between the first electrode 541 and a second electrode 542 formed on the second substrate 52 to be described later, and a thickness dimension of each of the first reflection film 56 and the second reflection film 57, and is not limited to the configuration described above. For example, in a case where the reflection film of the dielectric multi-layered film is used as the reflection films 56 and 57 and the thickness dimension increases as a result, a configuration where the electrode fixing surface 511A and the reflection film fixing surface 512A are formed on the same plane, a configuration where a reflection film fixing groove having a cylindrical concave groove shape is formed at a center portion of the electrode fixing surface 511A and the reflection film fixing surface 512A is formed at a lower surface of the reflection film fixing groove or the like may be possible.

Here, the electrostatic attractive force acting between the first and second electrodes 541 and 542 is inversely proportional to the square of the distance between the first and second electrodes 541 and 542. Therefore, as a distance between the first and second electrodes 541 and 542 is short, the amount of variation of G with respect to a voltage value of the electrostatic attractive force increases. Especially, in a case where the variable-dimension of the gap G is minute (for example, 250 to 450 nm) like this embodiment, the control of the gap G becomes difficult. Therefore, even when the reflection film fixing groove is formed, it is preferable that the depth dimension of the electrode forming groove 511 is secured to some extent, and in this embodiment, for example, it is preferable to carry out the formation at 1

In addition, the reflection film fixing surface 512A of the reflection film fixing portion 512 is preferably designed to have a groove depth in consideration of a wavelength band transmitted through the etalon 5. For example, in this embodiment, an initial value of the gap G (the size of gap G when a voltage is not applied between the first and second electrodes 541 and 542) between the first and second reflection films 56 and 57 is set to 450 nm, such that the second reflection film 57 can be displaced until the gap G becomes, for example, 250 nm due to the application of a voltage between the first and second electrodes 541 and 542. Therefore, it is possible to selectively disperse light of the entire visible light wavelength band by the variation of the voltage between the first and second electrodes 541 and 542 and transmit it. In this case, the film thickness of each of the first and second reflection films 56 and 57, and the height dimension of each of the reflection film fixing surface 512A and the electrode fixing surface 511A may be set to values capable of allowing the gap G to be displaced within a range of 250 to 450 nm.

The first reflection film 56 having, for example, a diameter of about 3 mm and a circle shape is fixed to the reflection film fixing surface 512A. This reflection film 56 may be formed from a metal single layer film or a dielectric multi-layered film. As the metal single layer film, for example, an AgC single layer film may be used. As the dielectric multi-layered film, for example, a dielectric multi-layered film having a high refraction layer of TiO₂ and a low refraction layer of SiO₂ may be used. Here, in a case where the first reflection film 56 is formed from the metal single layer such as the AgC single layer, it is possible to form a reflection film capable of covering the entire visible light wavelength band as the wavelength band that can be dispersed in the etalon 5. In addition, in a case where the first reflection film 56 is formed from the dielectric multi-layered film, the wavelength band that can be dispersed in the etalon 5 is narrower than that of the AgC single layer film, but the transmittance of the dispersed light is high and a half-value width of the transmittance is narrow, such that resolution may be increased.

In addition, the first substrate 51 has an antireflection film (AR) (not shown) on a lower surface opposite to the upper surface facing the second substrate 52 at a position corresponding to the first reflection film 56. The antireflection film is formed by alternately laminating a low refraction ratio film and a high refraction ratio film and reduces a reflection ratio of a visible light at a surface of the first electrode 51, thereby increasing transmittance.

### 3-1-2. Configuration of Second Substrate

The second substrate 52 is formed by etching, for example, a glass base material having a thickness of 200 μm.

Specifically, as shown in FIG. 2, in a plan view, the second substrate 52 includes a circle-shaped movable portion 521 formed with the substrate center point acting as the center, and a connecting and maintaining portion 522 that is formed coaxially with the movable portion 521 and maintains the movable portion 521.

The movable portion 521 is formed to have a thickness dimension larger than that of the connecting and maintaining portion 522. For example, in this embodiment, the movable portion 521 is formed to have the same thickness dimension as that of the second substrate 52, that is, about 200 μm. In addition, the movable portion 521 includes a movable surface 521A parallel with the reflection film fixing portion 512. The second reflection film 57 facing the first reflection film 56 via the gap G is fixed to the movable surface 521A.

Here, as the second reflection film 57, a reflection film having the same configuration as that of the above-described first reflection film 56 may be used.

In addition, the movable portion 521 has an antireflection film (AR) (not shown) on an upper surface opposite to the movable surface 521A at a position corresponding to the second reflection film 57. The antireflection film has the same configuration as that of the antireflection film formed on the first substrate 51 and is formed by alternately laminating a low refraction ratio film and a high refraction ratio film.

The connecting and maintaining portion 522 is a diaphragm surrounding the periphery of the movable portion 521 and is formed to have a thickness dimension of, for example, about 50 μm. On a surface of the connecting and maintaining portion 522, which faces the first substrate 51, a ring-shaped second electrode 542 facing the first electrode 541 via an electromagnetic gap G of about 1 μm is formed. Here, the second electrode 542 and the first electrode 541 described above make up the electrostatic actuator 54.

In addition, a pair of second lead-out electrodes 542A is formed to extend from a part of an outer circumferential edge of the second electrode 542 toward an outer circumference direction. Specifically, as shown in FIGS. 2 and 4, each of the second lead-out electrodes 542A is formed to extend toward a right-upper direction and a left-lower direction of the etalon 5 in the etalon plan view. Here, the second lead-out electrodes 542A are formed to be in point symmetry with respect to a substrate center point of the second substrate 52 on a diagonal line of the second substrate 52. Therefore, when the first and second substrates 51 and 52 are bonded, the second lead-out electrodes 542A face the concave groove 515 of the first substrate 51. At a distal end of each of the second lead-out electrodes 542A, a second electrode pad 542B is formed. The second electrode pad 542B connects to the voltage control unit 6.

When the electrostatic actuator 54 is operated, a voltage is applied to the pair of second electrode pads 542B by the voltage control unit 6, respectively.

In such a configuration, similarly to the first lead-out electrode 541A, even when either one of the pair of second lead-out electrodes 542A is disconnected, the voltage maybe applied to the second electrode 542 from the other second lead-out electrode 542A.

In addition, in a configuration where the second electrode 542 is connected to the voltage control unit 6 by the pair of second lead-out electrodes 542A, an electric resistance may be decreased compared to a configuration where a single second lead-out electrode 542A is provided and thereby energy loss caused by the increase of the electric resistance may be decreased. Therefore, a driving voltage necessary for applying a predetermined charge to the second electrode 542 may be decreased and thereby power-saving may be achieved.

In addition, one of the second lead-out electrodes 542A is extracted from the right-upper end edge of the ring-shaped second electrode 542 and the other is extracted from the left-lower end edge of the second electrode 542. Therefore, in the second electrode 542, a parallel circuit is formed between the second lead-out electrode 542A extracted toward the right-upper direction and the second lead-out electrode 542A extracted toward the left-lower direction, and thereby the electric resistance in the second electrode 542 may be decreased.

### 3-2. Configuration of Voltage Control Unit

The voltage control unit 6 makes up the wavelength-variable interference filter of the embodiment of the invention together with the etalon 5. The voltage control unit 6 controls a voltage applied to the first and second electrodes 541 and 542 of the electrostatic actuator 54 based on a control signal input from the control device 4. At this time, as described above, the voltage control unit 6 applies a voltage to the pair of first lead-out electrodes 541A and the pair of second lead-out electrodes 542A and thereby drives the electrostatic actuator 54.

### 4. Configuration of Control Device

The control device 4 controls the entire operations of the color measuring device 1.

As the control device 4, for example, a general personal computer, a mobile information terminal, a computer dedicated to color-measuring or the like may be used.

As shown in FIG. 1, the control device 4 includes alight source control unit 41, a color measuring sensor control unit 42, a color measurement processing unit 43 or the like.

The light source control unit 41 connects to the light source device 2. The light source control unit 41 outputs a predetermined control signal to the light source device 2 based on a user's setting input and allows the light source device 2 to emit white light with a predetermined brightness.

The color measuring sensor control unit 42 connects to the color measuring sensor 3. The color measuring sensor control unit 42 sets a wavelength of light to be received by the color measuring sensor 3 for example, based on a user's setting input, and outputs a control signal instructing the detection of a light-receiving amount of light with this wavelength to the color measuring sensor 3. Therefore, the voltage control unit 6 of the color measuring sensor 3 sets the application voltage to the electrostatic actuator 54 so as to transmit only a wavelength of light wanted by the user, based on the control signal.

### 5. Effect of the Embodiment

As described above, in the color measuring device 1 of above-described embodiment, the etalon 5 provided to the color measuring sensor 3 includes the electrostatic actuator 54 that adjusts the dimension of the gap G between the first and second reflection films 56 and 57, and the electrostatic actuator 54 includes the first electrode 541 formed in the first substrate 51 and the second electrode 542 formed in the second substrate 52. The pair of first lead-out electrodes 541A connects to the first electrode 541 and the driving voltage is applied from the pair of first lead-out electrodes 541A to the first electrode 541. The pair of second lead-out electrodes 542A also connects to the second electrode 542 and the driving voltage is applied from the pair of second lead-out electrodes 542A to the second electrode 542.

In this configuration, even when either one of the pair of first lead-out electrodes 541A (second lead-out electrodes 542A) is disconnected, the driving voltage may be applied to the first electrode 541 (second electrode 542) from the other first lead-out electrode 541A (second lead-out electrode 542A), and thereby interconnection reliability is improved. Therefore, it is possible to stably operate the etalon 5.

In addition, in a case where the voltage is applied to the first electrode 541 (second electrode 542) by using the pair of first lead-out electrodes 541A (second lead-out electrodes 542A), an electric resistance in the first lead-out electrodes 541A (second lead-out electrodes 542A) may be decreased compared to a case of using a single first lead-out electrode 541A (second lead-out electrode 542A). In addition, since the pair of first lead-out electrodes 541A (second lead-out electrodes 542A) connects to the first electrode 541 (second electrode 542) to make a parallel circuit, electric resistance in the first electrode 541 (second electrode 542) also decreases. Therefore, energy loss caused by the electric resistance may be suppressed and thereby it is possible to decrease power consumption at the time of driving the etalon 5.

Therefore, the reliability in the color measuring sensor 3 provided with the etalon 5 and in the color measuring device 1 is increased and power-saving may be achieved.

In addition, each of the first and second lead-out electrodes 541A and 542A is disposed at a position not overlapping each other in a plan view.

Specifically, the first lead-out electrodes 541A are disposed to be in point symmetry with respect to a substrate center of the first substrate 51 on a diagonal line of the first substrate 51. The second lead-out electrodes 542A are disposed to be in point symmetry with respect to a substrate center of the second substrate 52 on a diagonal line of the second substrate 52.

In this configuration, since the first lead-out electrodes 541A and the second lead-out electrodes 542A are not opposed to each other, an electrostatic attractive force does not act therebetween. Therefore, the movable portion 521 is displaced by only the electrostatic attractive force acting between the first and second electrodes 541 and 542 and thereby the displacement amount of the movable portion 521 is made to be uniform. That is, it is possible to displace the movable portion 521 with the movable surface 521A of the movable portion 521 maintained to be parallel with the reflection film fixing surface 512A and thereby it is possible to realize the stable operation of the etalon 5.

In addition, as described above, since the pair of second lead-out electrodes 542A are formed to be in point symmetry with respect to a substrate center point of the second substrate 52, the bending balance of the connecting and maintaining portion 522 can be made to be uniform, and it is possible to displace the movable portion 521 maintained to be parallel with the reflection film fixing surface 512A.

In addition, the first and second concave grooves 514 and 515 are formed on the first substrate 51 along diagonal lines thereof. In the first substrate 51, the first lead-out electrodes 541A are formed in the first concave grooves 514. In the second substrate 52, each of the second lead-out electrodes 542A is formed at a position opposing each of the second concave grooves 515.

In this configuration, the first and second substrates 51 and 52 can be bonded together with the first and second substrates 51 and 52 made to be parallel to each other, without the first and second lead-out electrodes 541A and 542A being interposed at a bonding portion of the first and second substrates 51 and 52. That is, in a configuration where the first and second concave grooves 514 and 515 are not formed, since the first and second lead-out electrodes 541A and 542A are interposed at a bonding portion of the first and second substrates 51 and 52, for example, in a case where the surfaces of the first and second substrates 51 and 52 are activated to be bonded by an optical contact, the bonding portion may be peeled off due to the lead-out electrodes 541A and 542A interposed at the bonding portion. In addition, in a case where the first and second substrates 51 and 52 are bonded by an adhesive layer such as an adhesive agent, the substrates 51 and 52 may be distorted at a position where the lead-out electrodes 541A and 542A are inserted and thereby the movable portion 521 may not be parallel with the reflection film fixing surface 512A. Contrary to this, as described above, the first and second concave grooves 514 and 515 are formed correspondingly to the forming positions of the first and second lead-out electrodes 541A and 542A, such that the first and second lead-out electrodes 541A and 542A are not interposed at the bonding portion and thereby the above-described peeling off or distortion may not occur.

### Another Embodiment

In addition, it should be understood that the invention is not limited to the above-described embodiment, but various changes and improvements without departing from a scope capable of achieving the advantage of the invention are included in the invention.

For example, in the above-described embodiment, in a plan view shown in FIG. 2, the first lead-out electrodes 541A are disposed on a diagonal line extending from a left-upper side to a right-lower side of the first substrate 51 and the second lead-out electrodes 542A are disposed on a diagonal line extending from a right-upper side to a left-lower side of the second substrate 52, but the invention is not limited thereto. For example, a configuration where the first lead-out electrodes 541A are formed in a direction from a right-upper side of the first substrate 51 to a left-lower side and the second lead-out electrodes 542A are formed in a direction from a left-upper side of the second substrate 52 to a right-lower side may be possible.

In addition, in consideration of the ease of forming the first and second electrode pads 541B and 542B, interconnection connecting efficiency or the like, a configuration where the first and second lead-out electrodes 541A and 542A are disposed along the diagonal lines of the first and second substrates 51 and 52 is exemplified, but the invention is not limited thereto. For example, in a plan view of the etalon shown in FIG. 2, when a horizontal direction on paper is set as a x-axis direction, a vertical direction on paper is set as an y-axis direction, a substrate center point is set as the origin, and the size of the diameter to the outer circumferential edge of the first and second electrodes 541 and 542 is set as “d”, in the first substrate 51, a configuration where a first lead-out electrode that extends from a point (+d, o) toward +x direction and a first lead-out electrode that extends from a point (−d, 0) toward −x direction are formed in an outer circumferential edge of the first electrode 541 may be possible. Similarly, in the second substrate 52, a configuration where a second lead-out electrode that extends from a point (0, +d) toward +y direction and a second lead-out electrode that extends from a point (0, −d) toward −y direction are formed in an outer circumferential edge of the second electrode 542 may be possible. Also, in such a configuration, in the second substrate, since a pair of second lead-out electrodes is formed in an outer circumferential edge of the second substrate 542 to be in point symmetry with respect to a substrate center point, the bending balance of the movable portion 521 is not disrupted, and thereby it is possible to displace the movable portion 521 while maintaining it to be parallel with the reflection film fixing surface 512A. In addition, since the distance from the first and second electrodes 51 and 52 to the first and second electrode pads 541B and 542B becomes short, respectively, the electric resistance of the first and second lead-out electrodes 541A and 542A decreases and thereby power-saving may be furthermore achieved.

In addition, in the etalon of FIG. 2, for example, the first lead-out electrode may be formed to extend from the first electrode 541 toward a left-upper apex and a left-lower apex, and the second lead-out electrode may be formed to extend from the second electrode 542 toward a right-lower apex and a right-upper apex. However, in this case, in the second substrate 52, the strength of the right side of the connecting and maintaining portion 522 may increase due to the second lead-out electrode and may be difficult to bend. In this case, dummy electrodes having the same strength as that of the second lead-out electrodes may be formed to extend from the second electrode 542 toward a left-upper apex and a left-lower apex. In addition, in this case, the dummy electrodes and the second electrode 542 may be insulated or the dummy electrodes may be substituted with non-conductive film having the same tensile strength as that of the second lead-out electrode so that the electrostatic attractive force does not act between the first lead-out electrode 541A and the dummy electrodes.

In addition, in the above-described embodiment, a configuration where the first and second concave grooves 514 and 515 are formed in the first substrate 51 is exemplified, but a configuration where the first and second concave grooves are formed in the second substrate 52 may be possible. However, in the above-described embodiment, the first substrate 51 is a substrate having a thickness of 500 μm, and the second substrate 52 is a substrate having a thickness of 200 μm, and when these grooves are formed, it is necessary that an electrode forming groove for forming the second electrode 542 is first formed on a surface of the second substrate 52, which faces the first substrate 51, and then grooves having the same depth dimension as that of the electrode forming groove are formed. In this case, problems are generated in that the strength of the second substrate 52 decreases, the etching process becomes complicated, the etching accuracy decreases or the like. By increasing the thickness dimension of the second substrate 52, even when the grooves are formed, it may be possible to realize a configuration where a sufficient strength is obtained and the movable portion 521 is not easily bent. However, in this case, there is a problem in that since the amount of etching for forming the connecting and maintaining portion 522 increases, the etching time increases. Therefore, it is preferable that the concave grooves are formed in the first substrate 51, like the above-described embodiment.

In addition, in the above-described embodiment, an example where the etalon 5 includes the movable portion 521 provided on the second substrate 52 and the movable portion 521 of the second substrate 52 moves to be displaced toward the first substrate 51 is exemplified, but a configuration where the movable portion is provided on the first substrate 51 and the movable portion moves to be displaced toward the second substrate 52 side may be possible. In addition, a configuration where the movable portion is provided on each of the first and second substrate 51 and 52, and each of the movable portions can be displaced in a thickness direction or the like may be possible.

In addition, in the above-described embodiment, the color measuring sensor 3 is exemplified as an optical filter module, and the color measuring device 1 is exemplified as an analysis device, but it is not limited thereto.

For example, the optical filter module may be used as a gas detecting module in which a light receiving element receives light emitted from the etalon 5 that is an optical filter device to detect an absorption wavelength unique to gas or may be used as a gas detecting device that determines a kind of gas from the absorption wavelength detected by the gas detecting module.

In addition, for example, the optical filter module may be used as an optical communication module that extracts a desired wavelength of light transmitted by, for example, a light transmitting medium such as an optical fiber or the like. In addition, the optical filter module may be used as an optical communication device that decodes data from light extracted by the optical communication module and extracts data transmitted by light, as an analysis device.

The detailed structure and sequences at the time of implementing the invention may be changed to another structure or the like without departing from a scope capable of achieving the advantage of the invention.

The entire disclosure of Japanese Patent Application No. 2010-095711, filed Apr. 19, 2010 is expressly incorporated by reference herein.

What is claimed is:

1. An optical filter device comprising:
a first substrate;
a second substrate that faces the first substrate;
a first reflection film that is provided on the first substrate;
a second reflection film that is provided on the second substrate to face the first reflection film;
a first electrode that is provided on the first substrate;
a second electrode that is provided on the second substrate to face the first electrode;
a pair of first lead-out electrodes that is provided on the first substrate to connect to the first electrode; and
a pair of second lead-out electrodes that is provided on the second substrate to connect to the second electrode.

2. The optical filter device according to claim 1,
wherein in a plan view of the first and second substrates seen in a thickness direction, the first lead-out electrodes and the second lead-out electrodes are disposed at positions not overlapping each other.

3. The optical filter device according to claim 2,
wherein the first and second substrates are formed in a rectangular shape,
the pair of first lead-out electrodes is disposed at positions that are in point symmetry with respect to a substrate center on a diagonal line of the first substrate, and
the pair of second lead-out electrodes is disposed at positions that are in point symmetry with respect to a substrate center on a diagonal line of the second substrate,

4. The optical filter device according to claim 1,
wherein at least one of the first and second substrates has concave grooves corresponding to positions where the pair of first lead-out electrodes and the pair of second lead-out electrodes are disposed, in a plan view of the first and second substrates seen in a thickness direction.

5. An optical filter device comprising:
a first reflection film;
a second reflection film that faces the first reflection film;
a first electrode formed at a periphery of the first reflection film;
a second electrode formed at a periphery of the second reflection film to face the first electrode;
a pair of first lead-out electrodes that connects to the first electrode; and
a pair of second lead-out electrodes that connects to the second electrode,
wherein a parallel circuit is formed between one of the pair of first lead-out electrodes and the other first lead-out electrode with the first electrode interposed therebetween, and
a parallel circuit is formed between one of the pair of second lead-out electrodes and the other second lead-out electrode with the second electrode interposed therebetween.

6. The optical filter device according to claim 5,
wherein in a plan view of the first and second substrates seen in a thickness direction, the first lead-out electrodes and the second lead-out electrodes are disposed at positions not overlapping each other.

7. The optical filter device according to claim 6,
wherein the first and second substrates are formed in a rectangular shape,
the pair of first lead-out electrodes is disposed at positions that are in point symmetry with respect to a substrate center on a diagonal line of the first substrate, and
the pair of second lead-out electrodes is disposed at positions that are in point symmetry with respect to a substrate center on a diagonal line of the second substrate.

8. The optical filter device according to claim 7,
wherein at least one of the first and second substrates has concave grooves corresponding to positions where the pair of first lead-out electrodes and the pair of second lead-out electrodes are disposed, in a plan view of the first and second substrates seen in a thickness direction.
